(19) United States
(12) Patent Application Publication
(10) Pub. No.: US 2004/0028582 A1
(43) Pub. Date: Feb. 12, 2004

(54) Crystallization process for producing fine crystal products

(75) Inventors: Stephen Thomas Carpenter, East Sussex (GB); George Robert Wellman, Wayne, PA (US)

Correspondence Address: SMITHKLINE BEECHAM CORPORATION, CORPORATE INTELLECTUAL PROPERTY-US, UW2220, P. O. BOX 1539, KING OF PRUSSIA, PA, 19406-0939, US

(73) Assignees: SmithKline Beecham Corporation; SmithKline Beecham p.l.c.

(21) Appl. No.: 10/427,025

(22) Filed: Apr. 30, 2003

Related U.S. Application Data
(63) Continuation of application No. 09/936,194, filed on Dec. 7, 2001, now abandoned.
Application No. 09/936,194 is a 371 of international application No. PCT/GB00/00866, filed on Mar. 9, 2000.

(30) Foreign Application Priority Data
Mar. 10, 1999 (GB) 9905512.1

(51) Int. Cl. B01D 9/00

(52) U.S. Cl. 422/245.1

(57) ABSTRACT

The invention relates to a process for the crystallisation of a chemical substance, and more particularly a substance to be used as a pharmaceutically active agent.

The present invention relates to a process for the crystallisation of a chemical substance, and more particularly a substance to be used as a pharmaceutically active agent.

Crystallisation is a well known technique for the purification of chemical compounds. Crystalline products prepared using traditional batch methodology may vary; for example in the degree of agglomeration experienced and the habit and size of individual crystals so formed. Moreover, in some circumstances, conventional batch mode crystallisation may give poor results, i.e. produces oils or crystals containing occluded impurities. There is therefore a need for a crystallisation process that gives rise to products of uniform and consistently small crystal size without the problems of batch processing, especially oiling or solvent inclusion. This is particularly true for pharmaceutically active compounds which might otherwise have to be milled to improve their bio-availability, or to increase their suitability in processing, e.g. the electrostatic deposition of active ingredients in tablet manufacture.

According to the present invention there is provided, in a first aspect, a process for the continuous crystallisation of an organic chemical compound which comprises contacting a stream of either the compound or a salt thereof dissolved in a solvent with a stream of anti-solvent or colder solvent, or a solution of an appropriate acid or base, and separating off the crystals formed.

Preferably the solute/solvent/antisolvent system will be one which has a fast precipitation time, as this gives rise to particularly small crystals. By ‘precipitation time’, we mean the time taken to observe precipitation in a mixed system e.g. cloudiness. Precipitation times can be determined by mixing and observing precipitation in individual solvent systems. Preferably the precipitation time will be less than 1 minute, especially less than 5 seconds, and particularly less than 1 second.

Precipitation times may be varied by adjusting the concentration of solute, the rates of flow of solution and anti-solvent, and the temperatures of the solvent and anti-solvent.

It should be recognised that the process of crystallisation can involve the initial formation of amorphous solid particles which rapidly change into a crystalline form.

For some applications it may prove satisfactory for the contacting process to be undertaken using a simple three-way pipe connection (for example a ‘T’ or ‘Y’-connection) provided that appropriate flow rates are used. Preferably, however, the contacting process is undertaken using conditions of high shear and turbulence.

Mixing devices suitable for use in this invention include known in-line mixers, e.g. of the type in which one or more turbulence-creating elements are located within a pipeline through which the components are caused to flow. Another suitable type of mixer is a homogeniser, e.g. of the type in which two liquid phases are forced under pressure through a biased valve. Suitable mixing devices may also include cavities subjected to high turbulence and or shear stress by means of turbines, propellers etc.

Another and preferred type of mixer for creating conditions of high shear and turbulence is a chamber wherein introduced fluids are subjected to intense rotational swirling, for example a vortex chamber of the type disclosed generally in EP-0153843-A (UK Atomic Energy Authority), the contents of which are incorporated herein by reference. The vortex chamber comprises a chamber of substantially circular cross section, e.g. generally cylindrical in shape, and having tangential inlets and an axial outlet. In such a mixer, the components are introduced via the tangential inlets where they experience swirling and intense mixing as they radially accelerate towards the centrally located outlet.

Preferably a vortex mixer (e.g. a Power Fluidics mixer) is used to create the conditions of high shear and turbulence. Preferably, the mixing is carried out under controlled residence times in the mixer as this gives rise to a product of uniform crystal size. Fast precipitation times give rise to particularly small crystals. Each stream is fed at high velocity into the central mixing chamber where it is mixed and accelerated towards to the central exit orifice. The internal diameter of such a vortex chamber is about 8 mm, and its height about 1 mm. A combination of small mixing chamber volume (approx. 0.05-0.1 ml) and high throughputs (preferably between 0.5L and 2L/min) generate typical residence times of less than 10 ms in a steady-state environment where all elements of the mixed stream experience minimal forward and backmixing. This effectively fixes supersaturation levels within the device with resultant tight control of particle size. Alternative dimensioned mixers may be used provided that the flow-rates can be sufficiently modulated to maintain high turbulence and uniform supersaturation conditions at similar residence times. By way of contrast, changes in supersaturation levels will typically occur in a conventional batch stirred reactor due to non-ideal mixing behaviour and both axial and radial heat gradients throughout the system.

Optionally the mixed stream of solute in solvent and anti-solvent is cooled during the mixing process and/or subsequent to it before the crystalline material is separated from the solvent stream. Optionally, in order to selectively control the size of the particles produced, the outlet flow from the mixer (e.g. the Power Fluidic mixer) can be passed through one or more tubular reactors (e.g. a flexible tubular reactor) before the crystals are separated off. Optionally such tubular reactors are cooled.

Preferably the compound to be crystallised is an active ingredient for a pharmaceutical composition. Particularly preferred compounds for crystallisation in accordance with the process of this invention are: Eprosartan methanesulphonate-(-(E)-(-[[2-butyl-1-[(4-carboxyphenyl)methyl]-1H-imidazol-5-yl]methylene]-2-thiophenepropanoic acid methanesulphonate); and Nabumetone-4-(6-methoxy-2-naphthalenyl)-2-butanone.

Preferably, the process is one in which the compound to be crystallised is the same as the compound dissolved in the solvent prior to addition of the anti-solvent (e.g. neutral molecule, free acid or base, acid-addition salt or base-addition salt). However the process can also be used where a solution containing the free acid or base of a compound is mixed under conditions of high turbulence with a solvent containing either acid or base to form a salt, or alternatively where a solution of a salt of a compound is rapidly mixed under conditions of high turbulence with a solvent containing an acid or base.

The utility of the invention will now be described by way of example and with reference to the accompanying drawings, in which:

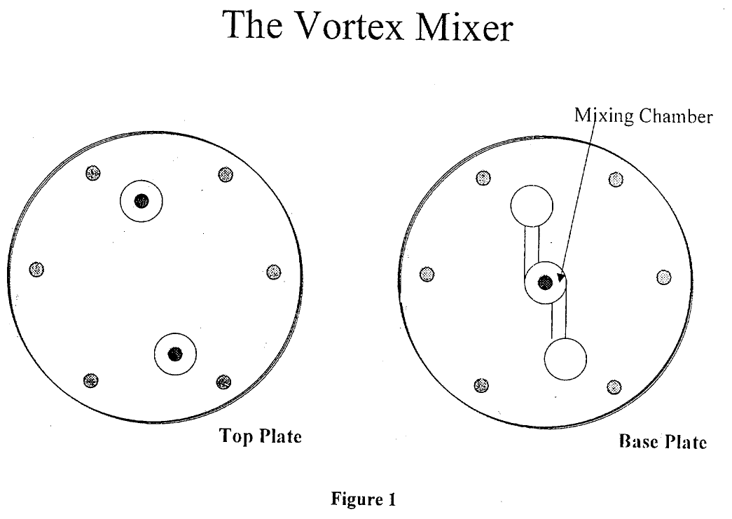

FIG. 1 Shows a mixing device in the form of a vortex chamber having two tangential inlets and an axial outlet;

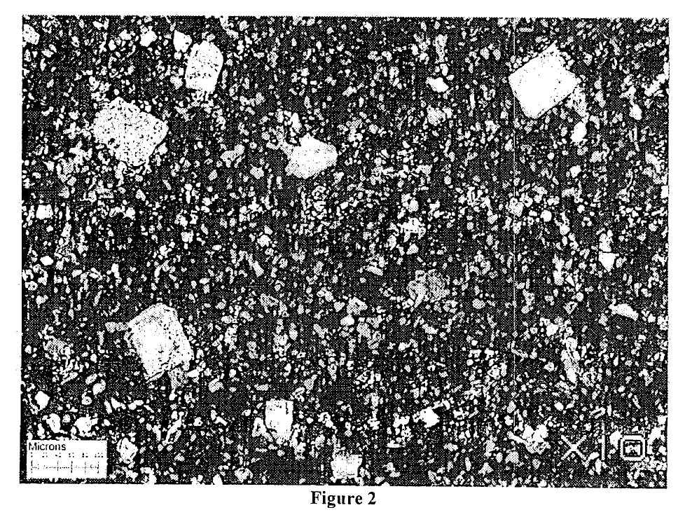

FIG. 2 Shows crystals of Eprosartan methanesulphonate obtained by batch crystallisation;

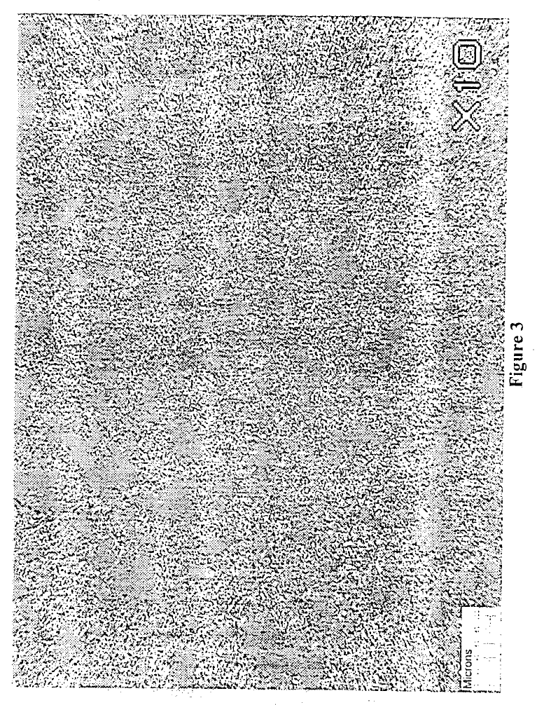

FIG. 3 Shows crystals of Eprosartan methanesulphonate prepared by continuous crystallisation using a vortex mixer;

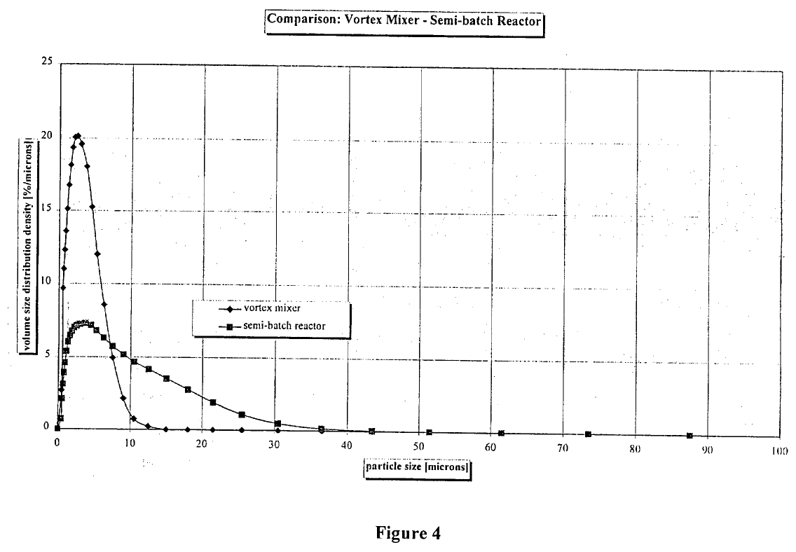

FIG. 4 Shows a comparison of particle sizes of Eprosartan methane sulphonate produced by continuous crystallisation and batch crystallisation;

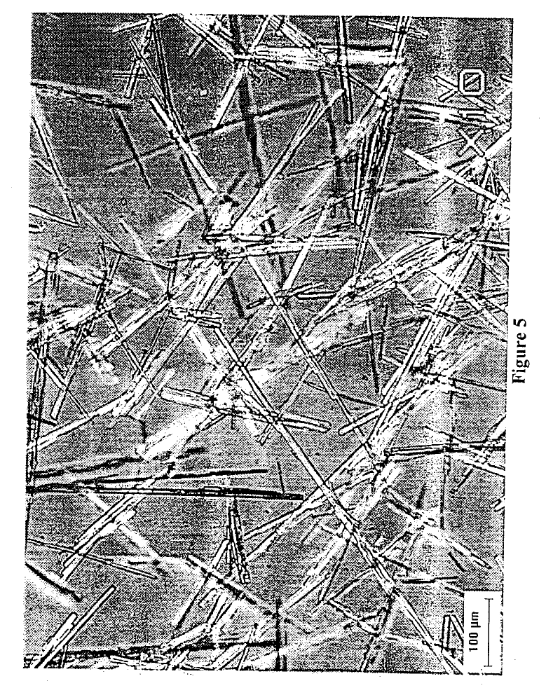

FIG. 5 Shows crystals of Nabumetone obtained by batch crystallisation;

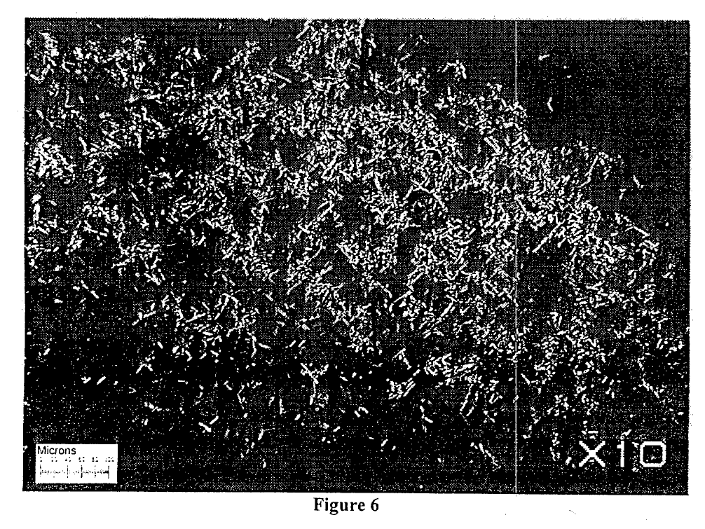

FIG. 6 Shows crystals of Nabumetone prepared by continuous crystallisation using a vortex mixer;

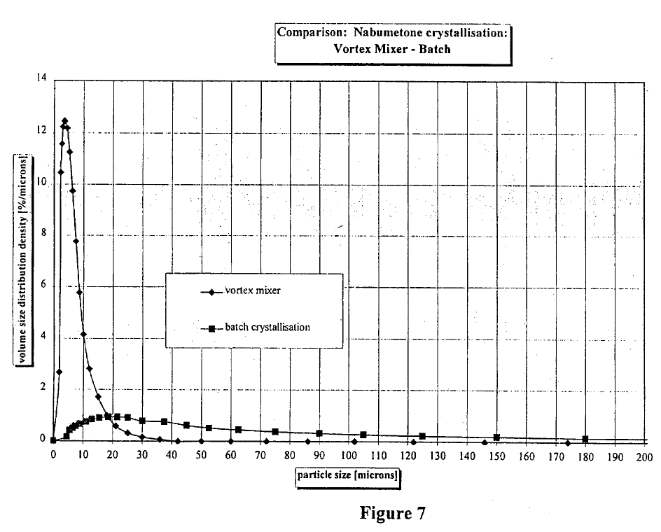

FIG. 7 Shows a comparison of particle sizes of Nabumetone crystals produced by continuous crystallisation and batch crystallisation.

### EXAMPLE 1

Eprosartan methanesulphonate-(-(E)-(-[[2-butyl-1-[(4-carboxyphenyl)methyl]-1H-imidazol-5-yl]methylene]-2-thiophenepropanoic acid methanesulphonate) is described in U.S. Pat. No. 5,185,351/EP 0 403 159. Preferably the crystallised eprosartan methanesulphonate has a d₉₀ of less than 10 microns.

Preferably the solution of the solute is a solution of Eprosartan methanesulphonate in acetic acid, preferably at an elevated temperature for example from 20° C. to 100° C., preferably 70° C. to 90° C. and especially between 75 to 85° C.

Preferably the solution of the solute is reasonably concentrated, for example between 5 and 40% w/v, preferably between 10 and 30% w/v and especially between 15% and 25% w/v.

Preferably the anti-solvent is ethyl acetate or tert-butyl methyl ether (TBME), especially TBME. Preferably the anti-solvent is used in a significant excess to the solution of solute, for example from a 3-fold to a 30-fold excess, preferably 6-fold to a 25-fold excess.

Preferably the anti-solvent is mixed at a temperature from −20° C. to 80° C., preferably 0° C. to 30° C. most preferably around 10° C. to 20° C.

Preferably the contacting process is undertaken in a vortex mixer.

It has been found that using a solution of Eprosartan methanesulphonate (concentration of 20% w/v) dissolved in acetic acid at around 80° C. and using an antisolvent of tert-butyl methyl ether at around 10° C., that crystals of a particularly advantageous small and uniform size and consistency are obtained (see FIG. 3). Particle size distributions were found to be narrow, uni-modal and near symmetrical with d₁₀, d₅₀ and d₉₀ values of 1, 3.5 and 7 micron respectively. There is good demonstrated reproducibility with no observed agglomeration. By comparison, the slow controlled addition of Eprosartan methanesulphonate/acetic acid solution to excess tert-butyl methyl ether with vigorous stirring in a semi-batch mode environment without use of a vortex mixer leads to a much broader size distribution of the generated particles (see FIG. 4).

### EXAMPLE 2

Nabumetone-(4-(6-methoxy-2-naphthalenyl)-2-butanone) is described in U.S. Pat. No. 4,061,779. Preferably the crystallised Nabumetone has a needle length of less than 20 microns.

Preferably the solution of the solute is a solution of Nabumetone in propan-2-ol, preferably at an elevated temperature for example from 20° C. to 82° C. and more preferably between 50° C. to 77° C.

Preferably the solution of the solute is at a concentration of 5 to 30% w/v, more preferably between 5 and 10% w/v.

Preferably the anti-solvent is water. Preferably the anti-solvent is used in an excess to the solution of solute, for example from a 4-fold to a 30-fold excess, preferably 4-fold to 10-fold.

Preferably the anti-solvent is mixed at a temperature from 0° C. to 50° C., more preferably 6° C. to 27° C.

Preferably the contacting process is undertaken in a vortex mixer.

It has been found that using a solution of Nabumetone (concentration of 5% w/v) dissolved in hot propan-2-ol and using water as an anti-solvent, that crystals of a particularly advantageous small and near-uniform size and consistency are obtained. Particle size distributions were found to be narrow, uni-modal and near symmetrical with d₁₀, d₅₀ and d₉₀ values of 2, 5 and 12 micron respectively (FIGS. 6 & 7). There is good demonstrated reproducibility with no observed agglomeration.

1. A process for the continuous crystallisation of an organic chemical compound which comprises contacting a stream of either the compound or a salt thereof dissolved in a solvent with a stream of anti-solvent or colder solvent, or a solution of an appropriate acid or base, and separating off the crystals formed.

2. A process according to claim 1 in which the contacting process is undertaken using conditions of high shear and turbulence.

3. A process according to claims 1 or 2 in which the solute/solvent/antisolvent system has a precipitation time of less than 5 seconds.

4. A process according to any one of claims 1 to 3 in which a vortex mixer or a three-way pipe connection is used to effect mixing.

5. A process according to any one of claims 1 to 4 in which the compound is not converted into a different salt form.

6. A process according to any one of claims 1 to 5 in which the compound is Eprosartan methanesulphonate using acetic acid as solvent and tert-butyl methyl ether as anti-solvent.

7. A process according to any one of claims 1 to 5 in which the compound is Nabumetone using propan-2-ol as solvent and water as antisolvent.

8. A process according to any one of claims 1 to 7 in which the compound to be crystallised is an active ingredient for a pharmaceutical composition.

9. A crystalline compound having small and uniform crystal size prepared by a process according to any one of claims 1 to 8.

10. Crystalline Eprosartan methanesulphonate with a d₉₀ value of less than 10 micron.

11. Crystalline Nabumetone with a d₉₀ value of less than 20 micron.
